(19) United States
(12) Patent Application Publication
(10) Pub. No.: US 2018/0068773 A1
(43) Pub. Date: Mar. 8, 2018

(54) Apparatus for Negative Stiffness

(71) Applicant: The Hong Kong Polytechnic University, Kowloon (HK)

(72) Inventors: Songye Zhu, Kowloon (HK); Xiang Shi, Kowloon (HK)

(73) Assignee: The Hong Kong Polytechnic University, Kowloon (HK)

(21) Appl. No.: 15/257,958

(22) Filed: Sep. 7, 2016

(51) Int. Cl. H01F 7/20

(52) U.S. Cl. CPC H01F 7/20

(57) ABSTRACT

An apparatus for negative stiffness including one or more solenoids for generating a magnetic field. A moveable magnet is moveable relative to the one or more solenoids through the one or more solenoids. The one or more solenoids are configurable to generate an at least substantially quadratic magnetic field about an equilibrium position at which the resultant force on the moveable magnet is zero. Depending on the respective pole orientation, generating a quadratic magnetic field about an equilibrium position provides a substantially linear negative stiffness characteristic with displacement.

### FIELD OF THE INVENTION

The present invention relates to an apparatus for negative stiffness behaviour that can be applied in vibration isolation.

### BACKGROUND OF THE INVENTION

Negative stiffness can be thought of as the application of a force in a direction of displacement. This can have the effect of reducing the overall stiffness of a system to zero or at least close to zero. Introducing negative stiffness into a vibration isolation system dramatically reduces the transmissibility of external vibrations of the system.

Vibration isolation apparatuses that use a combination of negative stiffness and damping to suppress vibrations are known. Such negative stiffness devices, when used together with viscous or eddy-current dampers, are useful in a number of applications where it is desirable to isolate an object, such as a piece of equipment, from a source of vibrations. For example, negative stiffness dampers may be used in civil and mechanical structures such as bridges with stay cables and buildings where it is desirable to protect the structures from seismic activity. The devices also have other applications such as in laboratory equipment, where precise measurement is required, and in the aerospace industry.

Various negative stiffness devices have been proposed in passive, semi-active or active modes. Negative stiffness devices in passive mode do not require complex feedback systems and are, thus, often simpler and cheaper to manufacture and more robust than active or semi-active negative stiffness devices. However, a problem with conventional passive mode negative stiffness devices is that they can achieve only non-linear negative stiffness which is not favoured in both theoretical analysis and real life applications. An example of a negative stiffness device in passive mode is disclosed in US 20130118098 A1, which describes a device comprising an anchor frame and a movement frame that is laterally moveable relative to the anchor frame. The device also has a compressed spring and linkage connecting the spring to the movement frame to introduce negative stiffness into the system. In a rest state, the compressed spring does not apply a lateral force to the movement frame. In an engaged state, the compressed spring is configured to apply a lateral force to displace the movement frame in a lateral direction of a seismic load.

Active and semi-active negative stiffness devices use an external power supply, sensors and actuators in a feedback system to react to and mitigate vibrations. Active and semi-active control techniques usually achieve better control performance than passive techniques. The linear quadratic regulator algorithm, a commonly adopted optimal control theory for active dampers, may produce the hysteresis (i.e., force-deformation) relationship of a damper with an apparent negative-stiffness feature in some situations that benefits control effect. However, due to the requirement for a power supply and a feedback system and, hence increased complexity over a passive damper, active and semi-active dampers can be less robust than passive dampers and may have higher maintenance requirements. These observations have led to the exploration of a passive negative stiffness device that produces similar hysteresis to active dampers and achieves control performance comparable to those of active dampers.

It is an object of the present invention to provide a device with a passive design that is capable of achieving a substantially linear negative stiffness.

### SUMMARY OF THE INVENTION

In accordance with a first aspect of the present invention, there is provided an apparatus for negative stiffness comprising one or more solenoids for generating a magnetic field and a moveable magnet moveable relative to the one or more solenoids through the one or more solenoids, wherein the one or more solenoids are configured to generate an at least substantially quadratic magnetic field about an equilibrium position at which the resultant force on the moveable magnet is zero.

Advantageously, the generation of a substantially quadratic magnetic field through the one or more solenoids provides a substantially symmetrical linear negative stiffness about the equilibrium position with displacement of the moveable magnet.

The apparatus may comprise a plurality of solenoids including a first solenoid, a second solenoid arranged to one side of the first solenoid, and a third solenoid arranged to the opposite side of the first solenoid, wherein the plurality of solenoids are arranged relative to one another such that the quadratic magnetic field is substantially symmetrical about the first solenoid.

Advantageously, a negative stiffness apparatus comprising a plurality of solenoids enables the apparatus to be configured to provide a number of different stiffness characteristics. For example, the apparatus can be configured to produce a substantially linear positive stiffness by reversing the direction of current through the solenoids, a softening (reducing) positive or negative stiffness or a hardening (increasing) positive or negative stiffness with displacement by selectively energizing one or more solenoids, as appropriate.

The second and third solenoids may be equidistant from the first solenoid.

The apparatus may comprise one or more additional solenoids arranged to one side of the second solenoid and one or more additional solenoids arranged to one side of the third solenoid. The plurality of solenoids may be substantially equally spaced apart.

One or more solenoids may be arranged relative to the moveable magnet to provide softening negative stiffness with displacement of the moveable magnet, and one or more solenoids are arranged relative to the moveable magnet to provide hardening negative stiffness with displacement of the moveable magnet. The solenoids may be configurable to produce a combined negative stiffness with a substantially linear characteristic with displacement.

The coil geometry of each solenoid may be substantially the same. The plurality of solenoids is wound in the same direction.

The one or more solenoids and the moveable magnet may be configurable such that the magnetization of the one or more solenoids and the moveable magnet is in substantially the same direction.

The plurality of solenoids may be aligned along a common longitudinal axis. The moveable magnet may be fixedly mounted to a shaft for transmission of external vibrations to the moveable magnet.

The one or more solenoids and the moveable magnet may have a circular cross-section. The one or more solenoids and the moveable magnet may be substantially concentric.

In accordance with a second aspect of the present invention, there is provided a method of suppressing vibrations comprising the steps of: providing the apparatus as claimed in any preceding claim; connecting the moveable magnet to a source of external vibrations; energizing one or more solenoids to provide a desired stiffness characteristic with displacement of the moveable magnet, wherein the one or more solenoids are each energized with a current required to generate a substantially quadratic magnetic field through the one or more solenoids.

### BRIEF DESCRIPTION OF THE DRAWINGS

Preferred embodiments of the present invention will be explained in further detail below by way of examples and with reference to the accompanying drawings, in which:

FIG. 1(a) shows a cut-away perspective view of a negative stiffness device comprising a single solenoid;

FIG. 1(b) shows a cross section view of the negative stiffness device shown in FIG. 1(a) with the current flowing through the solenoid;

FIG. 1(c) shows a cross section view of the negative stiffness device shown in FIG. 1(a) with a magnet shown in two different positions within the solenoid;

FIG. 2 shows a plot of number of turns of the solenoid shown in FIGS. 1(a)-1(c) against distance from the centre of the solenoid;

FIG. 3 shows a plot of the interaction force between the magnetic field of the magnet and the magnetic field of the solenoid against distance from the center of the solenoid;

FIG. 4 shows a cut-away perspective view of a negative stiffness device comprising three solenoids;

FIG. 5 shows a plot of the interaction force between the magnetic fields of the solenoids and the magnet against displacement of the magnet from the equilibrium position of the negative stiffness device;

FIG. 6 shows a plot of the stiffness characteristic of the negative stiffness device due to the interaction between the solenoids and the magnet against displacement of the magnet from the equilibrium position of the negative stiffness device;

FIG. 7 shows a cross section view of the negative stiffness device shown in FIG. 4;

FIG. 8 shows a plot of the interaction force between the magnetic fields of the solenoids and the magnet against displacement of the magnet from the equilibrium position of a negative stiffness device with a first set of parameters;

FIG. 9 shows a plot of the stiffness characteristic of the negative stiffness device due to the interaction between the solenoids and the magnet against displacement of the magnet from the equilibrium position of a negative stiffness device with a first set of parameters;

FIG. 10 shows a plot of the interaction force between the magnetic fields of the solenoids and the magnet against displacement of the magnet from the equilibrium position of a negative stiffness device with a second set of parameters;

FIG. 11 shows a plot of the stiffness characteristic of the negative stiffness device due to the interaction between the solenoids and the magnet against displacement of the magnet from the equilibrium position of a negative stiffness device with a second set of parameters;

FIG. 12 shows a plot of the interaction force between the magnetic fields of the solenoids and the magnet against displacement of the magnet from the equilibrium position of the negative stiffness device of FIG. 8 when the pole orientations of the solenoids relative to the magnet are reversed;

FIG. 13 shows a plot of the stiffness characteristic of the negative stiffness device due to the interaction between the solenoids and the magnet against displacement of the magnet from the equilibrium position of the device of FIG. 8 when the pole orientations of the solenoids relative to the magnet are reversed;

FIG. 14 shows an experimental setup of a prototype negative stiffness device; and

FIG. 15 shows a plot of the interactive force between the magnetic field of the magnet and the solenoids against displacement of the magnet as measured by the setup of FIG. 14.

### DETAILED DESCRIPTION

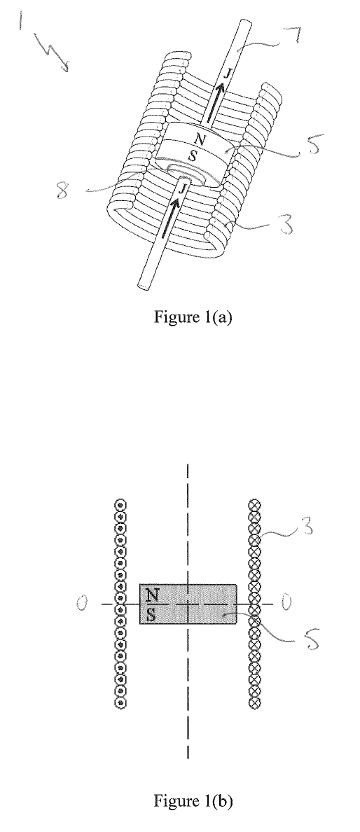

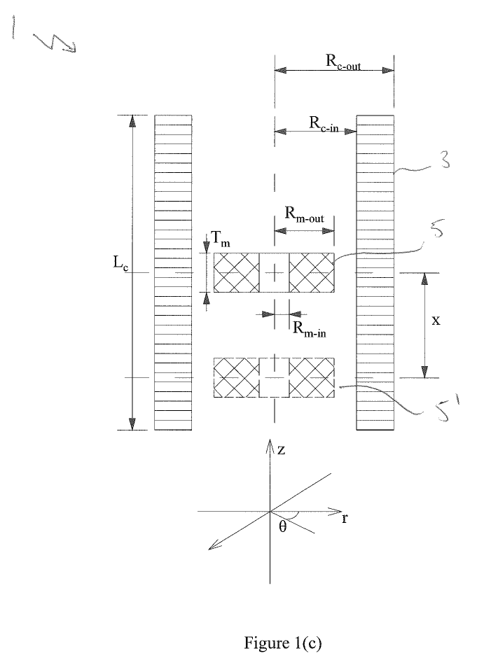

FIGS. 1(a) and 1(b) depict a theoretically ideal negative stiffness device 1 comprising a solenoid 3 and a permanent magnet 5 moveable within the solenoid 3 along the longitudinal axis of the solenoid 3. The permanent magnet 5 is fixedly mounted to a shaft 7 by spacers 8. The shaft 7 and, hence, the magnet 5 are linearly displaceable relative to and along the longitudinal axis of the solenoid 3. When a current flows through the solenoid 3, a magnetic field is generated by the solenoid 3 which interacts with the magnetic field of the permanent magnet 5. The magnetic field B generated by a solenoid is proportional to the current flowing through the solenoid I and the number of turns per unit lengths n. Thus, it is possible to manipulate the strength and gradient of a magnetic field inside the solenoid by adjusting the number of turns per unit length and/or the current flowing through the solenoid.

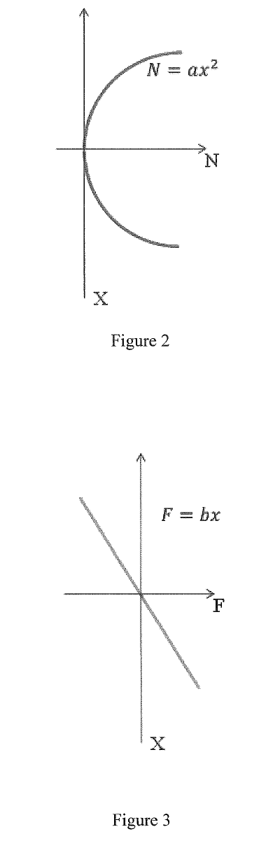

The total force acting on a magnet inside a uniform magnetic field is equal to zero because the magnetic forces from the North Pole and the South Pole of the magnet are cancelled mutually. For the ideal linear negative stiffness device shown in FIGS. 1(a) and 1(b), the number of turns is chosen to vary in a square manner either side and away from the center of the solenoid. Thus, with reference to FIG. 2, the number of turns changes in a quadratic form and symmetrically about the centre or equilibrium position. Consequently, with reference to FIG. 3, the interactive force between the solenoid and the permanent magnet increases linearly with displacement from the equilibrium position 0-0.

A theoretical model was built to simulate the behaviour of an ideal electromagnetic negative stiffness device (EM-NSD). According to the proposed configuration of EM-NSD depicted in FIG. 1(c), the magnet and the coil are coaxially arranged, and the magnet can only move in the longitudinal direction at various displacement x. The negative stiffness force of EM-NSD is generated by the interaction between the magnet and the magnetic field generated by the coil.

In the theoretical model, the magnet and the coil are simulated separately. The detailed notations of EM-NSD parameters are shown in FIG. 1(c). The permanent magnet is simulated by the Coulombian model, while the coil is simulated by the filament method. For simulation of the permanent magnet based on Coulombian model, many analytical solutions have been developed to simulate magnetic properties of a magnet with specific constraints, like shapes (Akoun and Yonnet, 1984; Agashe and Arnold, 2008; Babic and Akyel, 2008a) and polarizations (Ravaud et. al., 2008 and 2009a,b;). Similarly, many analytical expressions have also been developed to solve magnetic parameters created by coils based on the filament method (Babic and Akyel, 2008b; Akyel et. al, 2009; Ravaud et. al., 2010a, b). The following sets out the detailed procedures to simulate the EM-NSD.

The Coulombian model is based on the hypothesis of a magnetic monopole. Through the Coulombian model, the ring or cylindrical magnet is transferred to two surfaces with uniformly distributed magnetic monopoles. One surface is charged with a North Pole +σ* while the other with South Pole −σ*. Each monopole is charged with σ*, so σ* is also referred to as pole density in the Coulombian model. Mathematically, the pole density σ* is equal to the remanence of a magnet.

For a single magnetic monopole located on the plain surface of a magnet, the force received by the magnet when subjected to a magnetic field can be described by the following equation:

\vec{F}=σ*\vec{H} (1)

where σ* is the magnetic charge of a magnetic monopole or the pole density, and \vec{H} is the magnetic field strength created by the coil.

The magnetic force received by a permanent magnet inside a magnetic field at displacement x can be calculated by the supposition of the magnetic forces received by all magnetic monopoles, as shown by Eq. (2):

$$\vec{F} ( {R}_{m - out} , {R}_{m - in} , {T}_{m} , \vec{H} ( r , θ , z ) , x ) = {\sum }_{i = 1}^{2} {\int }_{{r}_{m} = {R}_{m - in}}^{{R}_{m - out}} {\int }_{θ = 0}^{2 π} \pm {σ}^{*} \vec{H} ( {r}_{m} , θ , {z}_{i} ) {dr}_{m} d θ \qquad ( 2 )$$

Where z₁=x+Tₘ/2, and z₂=x−Tₘ/2. Rₘ₋ₒᵤₜ is the outer radius of magnet, Rₘ₋ᵢₙ is the inner radius of magnet, Tₘ is the thickness of magnet, x is displacement. \vec{H} is the magnetic field created by the coil.

Because the magnet and the coil is arranged coaxially, the total force in the radial direction is always equal to zero, and only the magnetic force in the longitudinal direction need be considered. Consequently, Eq. (2) can be simplified to:

$${F}_{z} ( {R}_{m - out} , {R}_{m - in} , {T}_{m} , {H}_{z} ( r , θ , z ) , x ) = {\sum }_{i = 1}^{2} {\int }_{{r}_{m} = {R}_{m - in}}^{{rR}_{m - out}} {\int }_{θ = 0}^{2 π} \pm {σ}^{*} {H}_{z} ( {r}_{m} , θ , {z}_{i} ) {dr}_{m} d θ \\ {F}_{r} = 0 \qquad ( 3 )$$

where H_{z} is the magnetic field in longitudinal direction.

When a current flows through the coil, the coil will create a magnetic field. According to Biot-Savart Law, the magnetic field created by a coil at any space point can be expressed by following formula:

$$\vec{H} ( P ) = \frac{1}{4 π} {\int }_{z = - \frac{L}{2}}^{\frac{L}{2}} {\int }_{θ = 0}^{2 π} {\int }_{{r}_{c} = {R}_{c - in}}^{{R}_{c - out}} \vec{j} ( z ) \times \frac{\vec{r} - {\vec{r}}^{′}}{{\vert \vec{r} - {\vec{r}}^{′} \vert}^{3}} {dr}_{c} d θ dz \qquad ( 4 )$$

where R_{c-out} is the outer radius of the coil (m); R_{c-in} is the inner radius of the coil (m); L is the height of the coil (m); \vec{r}−\vec{r}′ is the space vector between point P(r,z) (where the magnetic field is calculated) and a point inside the coil (r′,z′, θ′)(FIG. 1(c)); and \vec{j}(z) is the volume current density (A/m²).

The volume current density \vec{j} is determined by the number of loops N times the current I inside the coil (NI). If NI varies with the longitudinal location along the coil, \vec{j} is non-uniformly distributed inside the coil. The relationship between \vec{j}(z) and NI(z) at various longitudinal locations z can be expressed by:

dNI(z)=\vec{j}(z)·(R_{c-out}−R_{c-in})dz (5)

For the geometry presented in FIG. 1(c), the magnetic field created by the coil can be decomposed into the longitudinal direction and radius direction, as shown by following equation:

\vec{H}(r,z)=Hᵣ(r,z)\vec{u}+H_{z}(r,z)\vec{u}_{z} (6)

Where \vec{u}ᵣ and \vec{u}_{z} are unit vector along radius and longitudinal direction.

The magnitude of two magnetic field components can be calculated by (Ravaud et. al., 2010b):

$$\begin{matrix}{H}_{r} ( r , z ) = \frac{1}{4 π} {\int }_{z = - \frac{L}{2}}^{\frac{L}{2}} {\int }_{θ = 0}^{2 π} {\int }_{r = {R}_{c - in}}^{{R}_{c - out}} j ( z ) \cdot \frac{{r}^{′} ( z - {z}^{′} ) cos {θ}^{′}}{{( {r}^{2} + {r}^{′2} - 2 {rr}^{′} cos {θ}^{′} + {( z - {z}^{′} )}^{2} )}^{\frac{3}{2}}} drd θ dz & ( 7 a ) \\ {H}_{z} ( r , z ) = \frac{1}{4 π} {\int }_{z = - \frac{L}{2}}^{\frac{L}{2}} {\int }_{θ = 0}^{2 π} {\int }_{r = {R}_{c - in}}^{{R}_{c - out}} j ( z ) \cdot \frac{{r}^{′} ( {r}^{′} - r cos {θ}^{′} )}{{( {r}^{2} + {r}^{′2} - 2 {rr}^{′} cos {θ}^{′} + {( z - {z}^{′} )}^{2} )}^{\frac{3}{2}}} drd θ dz & ( 7 b )\end{matrix}$$

Substituting Eq. (7a) into Eq. (3), the negative stiffness force of an EM-NSD can be calculated. Through this theoretical model, the stiffness forces of both a linear EM-NSD and a quasi-linear EM-NSD can be determined.

Although possible, a linear negative stiffness device based on a single solenoid or coil is practically difficult to manufacture owing to the requirement for a relatively precise number of turns symmetrically either side of the equilibrium position and the need for a wire for the coil which has a very uniform cross section throughout its length. It has been found that a more practically achievable negative stiffness device capable of achieving an approximately linear or quasi-linear negative stiffness is possible using more than one solenoid.

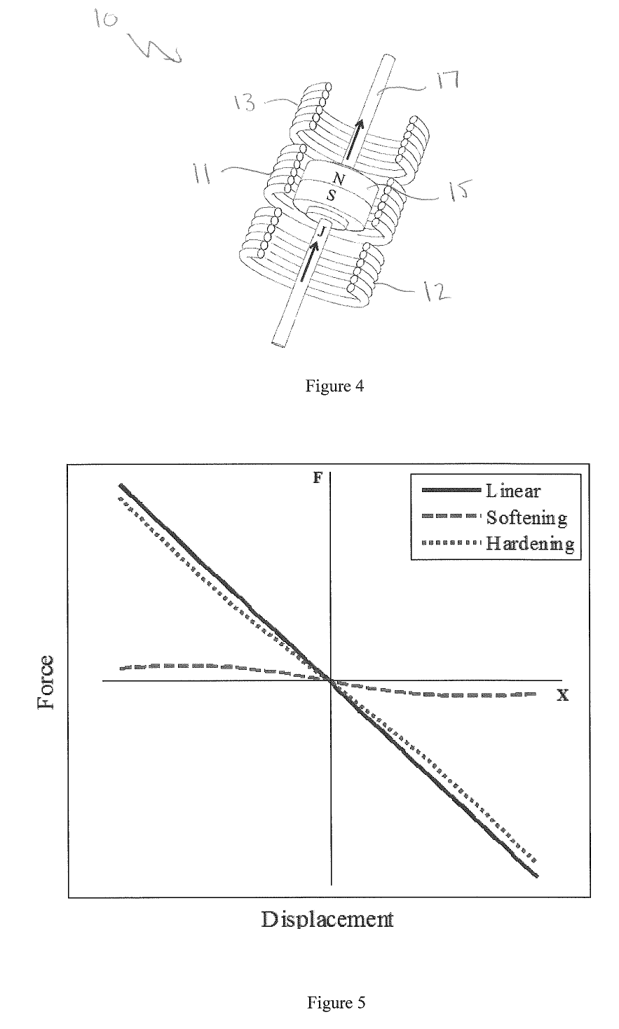

With reference to FIG. 4, there is shown a device 10 capable of achieving a quasi-linear negative stiffness comprising a first solenoid 11, a second solenoid 12, and a third solenoid 13. The second solenoid 12 and third solenoid 13 are arranged on either side of the first solenoid 11 and are substantially equally spaced from respective ends of the first solenoid 11. Each solenoid 11, 12, 13 is relatively fixed and substantially aligned along a common longitudinal axis so as to define a substantially cylindrical through bore. A cylindrical neodymium (NdFeB) permanent magnet 15 is fixedly mounted to a stainless steel shaft 17 by two fixing spacers 18 either side of the magnet 15. The shaft 17 and magnet 15 are disposed within the through bore and linearly moveable relative to the solenoids 11, 12, 13 along the common longitudinal axis. The shaft 17 may be configured to transmit external vibrations to the device 10 by connecting the shaft 17 to a source of vibrations.

Each solenoid 11, 12, 13 comprises a length of copper wire wound into a coil with a number of turns per unit length chosen according to desired magnetic force characteristics of the respective solenoids 11, 12, 13. The radius of the coil of each solenoid 11, 12, 13 and the thickness of each coil, that is the longitudinal distance between respective ends of each coil, is chosen to be substantially the same. Each coil is wound in the same direction such that a current flowing through the respective solenoids 11, 12, 13 in the same direction results in the solenoids 11, 12, 13 having the same pole orientations.

The coil geometry and number of turns of each coil may be chosen to be substantially the same. In some embodiments the number of turns of the first solenoid 11 may be chosen to be different from the number of turns of the second and third solenoids 12, 13. However, in embodiments in which the second and third solenoids 12, 13 are equally spaced from respective ends of the first solenoid 11, the second and third solenoids 12, 13 should have the same coil geometry and number of turns as one another other. This ensures a substantially symmetrical magnetic field is generated on either side of the first solenoid 11 for a given current flowing through the second and third solenoids 12, 13.

Since the solenoids 11, 12, 13 of the embodiment depicted in FIG. 4 are chosen to have substantially the same number of turns and since the second and third solenoids 12, 13 are equally spaced from respective adjacent ends of the first solenoid 11, when the current flowing through, and the magnetic field generated by, the second and third solenoids 12, 13 is substantially the same, the equilibrium position of the permanent magnet 15 is the center of the first solenoid 11. In this position, it can be seen that the permanent magnet 15 and the first solenoid 11 are concentric.

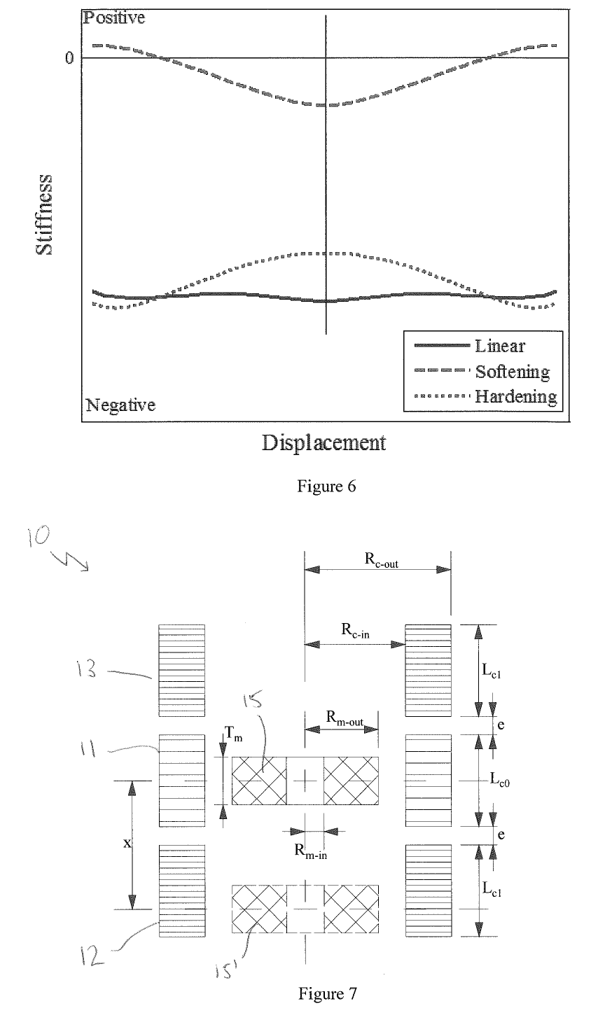

Referring to FIGS. 5 and 6, it can be observed that at the equilibrium position, the resultant force on the magnet 15 through interaction with the magnetic fields of the solenoids 11, 12, 13 is zero. This equilibrium position is highly unstable in that even slight displacement of the permanent magnet 15 from this position changes the resultant force on the permanent magnet 15 due to interaction with the respective magnetic fields of the solenoids 11, 12, 13.

The negative stiffness effect of the respective solenoids 11, 12, 13 on the permanent magnet 15 can be explained by considering first the effect of the first solenoid 11 (the middle solenoid) on the permanent magnet 15 in isolation and second the effect of the second and third solenoids 12, 13 (the outer solenoids) on the permanent magnet 15 in isolation.

It can be observed from the “softening” line of the chart shown in FIG. 5 that when the first solenoid 11 is supplied with a current and is, thus, magnetized such that the first solenoid 11 and the permanent magnet 15 have the same pole orientations, and when the shaft 17 is subjected to external forces J by vibrations such that the shaft 17 and, hence, the permanent magnet 15 are displaced away from the equilibrium position, the interactive force between the first coil 11 and the magnet 15 increases for a time with displacement X until it plateaus and gradually decreases.

This characteristic arises because the displacement of the permanent magnet 15 changes the relative positions of the respective magnetic fields such that interactive forces between the solenoid 11 and the magnet 15 increases with displacement. The repulsive force between the permanent magnet 15 and the solenoid 11 encourages the magnet 15 to move away from the equilibrium position in the direction of displacement. This repulsive force should be counterbalanced by an external force F in the opposite direction of the displacement X. This represents a negative-stiffness force-displacement relationship between the magnet 15 and the first solenoid 11.

As shown in FIG. 6, the negative stiffness due to the first or middle solenoid 11 (as depicted by “softening” line) is maximum at the equilibrium position and tends to zero when displaced either side of the equilibrium position. This can be thought of as a displacement softening negative stiffness. It can be observed that the negative stiffness due to the first solenoid 11 changes to a positive stiffness beyond a certain displacement of the magnet 15 away from the equilibrium position. This is due to the magnet 15 moving to a position relative to the first solenoid 11 at which the attractive forces between the magnets overcome the repulsive forces such that a resultant force in a direction toward the equilibrium position is produced.

It can also be observed from FIG. 5 that when the second and third solenoids 12, 13 are supplied with a current and are, thus, magnetized, the force between the magnet 15 and the second solenoid 12 or the third solenoid 13 depending on the direction of displacement, increases with displacement (as depicted by the “hardening” line). It is well known that the attractive or repulsive force between magnets (depending on the orientation of the respective magnet poles) increases non-linearly as the separation distance between the magnets decreases. Consequently, as the separation distance between the magnet 15 and either the second or third solenoid 12, 13 decreases, the attractive force increases non-linearly and increasingly encourages the magnet 15 to move in the direction of displacement. Thus, a force F in the opposite direction of the displacement X is required to keep the magnet 15 in equilibrium. Thus, the relationship between the magnet 15 and the outer solenoids 12, 13 also represents a negative-stiffness force-displacement, which can be thought of as a displacement hardening negative stiffness.

By balancing the magnetic fields generated by the respective solenoids 11, 12, 13 in relation to the separation distance between the outer solenoids 12, 13 and the middle solenoid 11, the combined interactive forces between the solenoids 11, 12, 13 and the magnet increases substantially linearly with displacement X (as depicted by the “Linear” line in FIG. 5). This balancing can be achieved by adjusting the number of turns per unit length of each solenoid 11, 12, 13 and/or adjusting the current flowing through the respective solenoids 11, 12, 13 to achieve a substantially quadratic magnetic field through the multiple solenoids about the equilibrium position. With reference to FIG. 6, it can be observed that the combined softening and hardening negative stiffness effects of the respective solenoids 11, 12, 13 gives rise to a substantially linear negative stiffness across a range of displacements (as depicted by the “Linear” line). This substantially linear negative stiffness effect was verified through simulation as shown in the examples below.

### EXAMPLES

With reference to FIG. 7, the first, second and third solenoids 11, 12, 13 and the permanent magnet 15 have a number of parameters (listed below with corresponding notation), which may be varied according to desired characteristics of the device 10.

| | |
|---|---|
| Tₘ (mm) | Thickness of magnet |
| Rₘ₋ₒᵤₜ (mm) | Outer radius of magnet |
| Rₘ₋ᵢₙ (mm) | Inner radius of magnet |
| L_{c0} (mm) | Thickness of first solenoid |
| L_{c} (mm) | Thickness of second/third solenoid |
| R_{c-out0} (mm) | Outer radius of middle coil |
| R_{c-in0} (mm) | Inner radius of middle coil |
| R_{c-out} (mm) | Outer radius of second/third solenoid |
| R_{c-in} (mm) | Inner radius of second/third solenoid |
| e (mm) | Gap between second/third solenoid and first solenoid |
| I₀ | Current of first solenoid |
| I | Current of second/third solenoid |
| N₀ | Number of turns of first solenoid |
| N | Number of turns of second/third solenoids |

### Example 1

In a first example the following parameters were chosen for the negative stiffness device 10:

| Parameters | |
|---|---|
| Tₘ (mm) | 20 |
| Rₘ₋ₒᵤₜ (mm) | 5 |
| Rₘ₋ᵢₙ (mm) | 24 |
| L_{c0} (mm) | 20 |
| L_{c} (mm) | 20 |
| R_{c-out0} (mm) | 40 |
| R_{c-in0} (mm) | 25 |
| R_{c-out} (mm) | 40 |
| R_{c-in} (mm) | 25 |
| e (mm) | 20 |
| I₀ (A) | 0.25 |
| I (A) | 5 |
| N₀ | 380 |
| N | 380 |

As can be seen from the parameters, the number of turns of the first, second and third solenoids 11, 12, 13 were chosen to be the same. However, the current flowing through the first solenoid 11 was chosen to be 1/20^{th} of the current flowing through the second and third solenoids 12, 13, respectively, to generate a quadratic magnetic field through the solenoids 11, 12, 13 about the equilibrium position and thereby produce a substantially linear combined force with displacement.

With reference to FIG. 6, when all three coils 11, 12, 13 were active, the combined force between the respective solenoids and the magnet 15 was approximately linear with displacement of the magnet 15 from the equilibrium position. Turning to FIG. 7, the combined negative stiffness due to the first, second, and third solenoids 11, 12, 13 on the magnet was approximately linear between a displacement of −10 mm and +10 mm as depicted by the “Total” line.

### Example 2

In a second example, the following parameters were chosen for the negative stiffness device 10:

| Parameters | |
|---|---|
| Tₘ (mm) | 20 |
| Rₘ₋ₒᵤₜ (mm) | 5 |
| Rₘ₋ᵢₙ (mm) | 24 |
| L_{c0} (mm) | 20 |
| L_{c1} (mm) | 30 |
| R_{c-out0} (mm) | 31 |
| R_{c-in0} (mm) | 30 |
| R_{c-out1} (mm) | 50 |
| R_{c-in1} (mm) | 25 |
| e₁ (mm) | 20 |
| I₀ (A) | 3 |
| I₁ (A) | 3 |
| N₀ | 10 |
| N₁ | 930 |

As can be seen from the parameters, the second and third solenoids 12, 13 were each chosen to have 93 turns while the first solenoid 11 was chosen to have 10 turns. However, the current flowing through each solenoid 11, 12, 13 was chosen to be the same at 3 A.

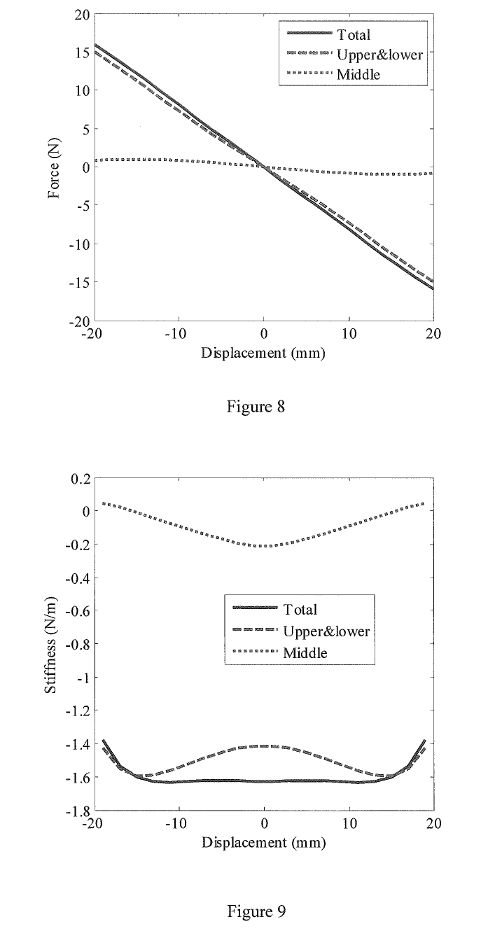

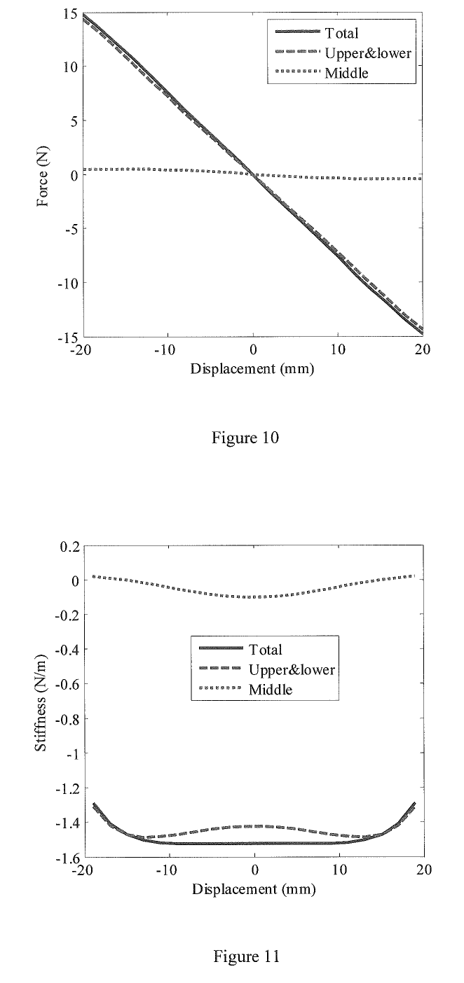

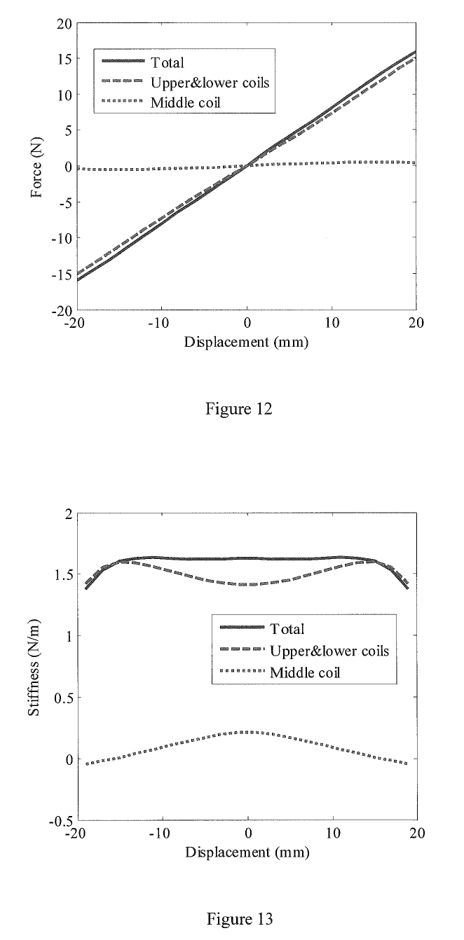

With reference to FIG. 8, when all three coils 11, 12, 13 were active, the combined force between the respective solenoids and the magnet 15 was approximately linear with displacement of the magnet 15 from the equilibrium position. Turning to FIG. 9, as in Example 1, the combined negative stiffness exerted by the first, second and third solenoids 11, 12, 13 on the magnet was approximately linear between a displacement of −10 mm and +10 mm as depicted by the “Total” line.

It can be observed from the two examples that the respective coils can be configured to produce an approximately quadratic magnetic field about the equilibrium position so as to produce a softening negative stiffness by the middle coil and a hardening negative stiffness by the outer coils which balances to produce a substantially linear negative stiffness.

Thus, the current in the outer coils of Example 1 is ×20 greater than that of the middle coil so that, for the same number of turns, the outer solenoids produce a much greater magnetic field than the middle solenoid which, for the separation distance between the outer solenoids and the middle solenoid, approximately conforms to a quadratic increase in magnetic field strength with distance from the equilibrium position.

Likewise, in Example 2, while the current flowing through the middle and outer solenoids is substantially the same, the number of turns of the outer solenoids is ×9.3 greater than that of the middle coil so that the outer solenoids produce a greater magnetic field strength than the middle solenoid which, for the separation distance between the outer solenoids and the middle solenoid, approximately conforms to a quadratic increase in magnetic field strength with distance from the equilibrium position.

### Example 3

In a third example, the same parameters as Example 1 were chosen except that the direction of current flowing through the respective solenoids 11, 12, 13 was reversed as follows:

| Parameters | |
|---|---|
| I₀ (A) | −0.25 |
| I (A) | −5 |

Reversing the direction of the flow of current reverses the magnetisation of the coils 11, 12, 13 and, hence, the direction of forces applied on the magnet upon displacement from the equilibrium position. For example, if the magnet 15 is displaced in an upward direction toward the second solenoid 12, the magnet 15 is attracted back toward the equilibrium position. Therefore, with reference to FIG. 11, it can be seen that reversing the direction of current flowing through the respective coils 11, 12, 13 gives rise to a positive stiffness. Nevertheless, it can be observed that reversing the direction of current flow has no effect on the softening or hardening stiffness feature of the respective solenoids 11, 12, 13 and that a substantially linear positive stiffness can be achieved for magnet displacement between −10 mm and +10 mm.

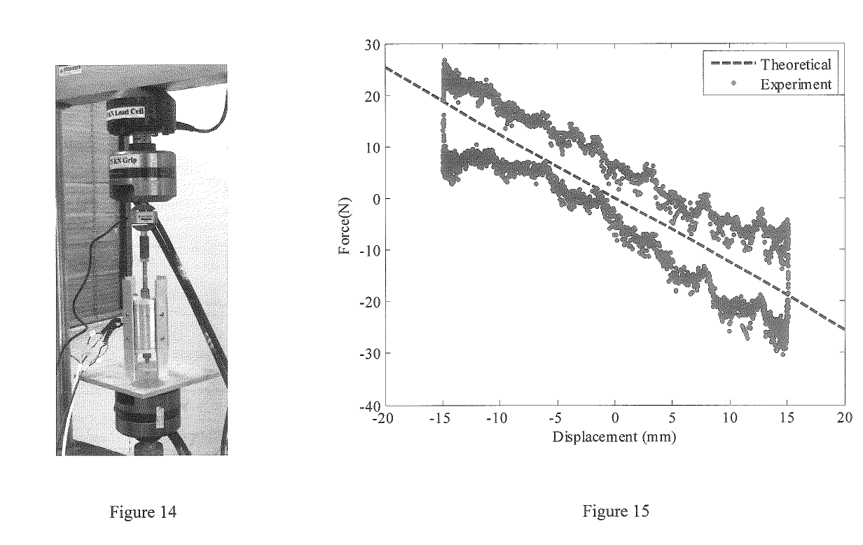

A prototype of the device 10 was constructed and tested through experimentation to verify the quasi-linear negative stiffness characteristic. A photograph of the experimental setup is depicted in FIG. 14 which shows a device comprising three solenoids. The following parameters were used:

| Parameters | |
|---|---|
| Magnet | NdFeB |
| Tₘ (mm) | 18 |
| Rₘ₋ₒᵤₜ (mm) | 5 |
| Rₘ₋ᵢₙ (mm) | 24 |
| L_{c0} (mm) | 16 |
| L_{c1} (mm) | 9 |
| R_{c-out0} (mm) | 38 |
| R_{c-in0} (mm) | 25 |
| R_{c-out1} (mm) | 38 |
| R_{c-in1} (mm) | 25 |
| e₁ (mm) | 26 |
| I₀ (A) | 0.5 |
| I₁ (A) | 5 |
| N₀ | 600 |
| N₁ | 300 |

The force was measured as a function of displacement of the magnet and a plot of the experimental results is provided in FIG. 15 together with a plot of the theoretical model. As can be seen, the prototype achieved an average quasi-linear force relationship with displacement and thus achieved a quasi-linear negative stiffness characteristic.

Although each of the above described embodiments comprises three solenoids, additional solenoids could be incorporated into the device to produce a more precise linear negative stiffness. For example, five solenoids could be used whereby a first or middle solenoid is provided at the center of the device, and two solenoids are provided on either side of the middle solenoid such that there is one outer solenoid on either side of the middle solenoid, and one inner solenoid arranged between the middle and outer solenoids. In such an arrangement, each solenoid may be substantially coaxially aligned and equally spaced apart from an adjacent solenoid. Likewise, the device could comprise 7, 9, 11, etc. solenoids, each substantially coaxially aligned and spaced apart such that the shaft and magnet is moveable through the respective solenoids. By choosing appropriate parameters for each solenoid such as the number of turns and current as dependant on the distance of each solenoid from the centre of the middle solenoid, it is possible to achieve an approximately quadratic magnetic field through the multiple solenoids and thereby achieve a substantially linear negative stiffness characteristic with displacement of the moveable magnet.

The use of solenoids offers the flexibility to adjust the negative stiffness characteristics of the device. For example, the magnitude of the negative stiffness can be adjusted depending on the size of current flowing through the respective solenoids. The use of solenoids also advantageously enables the device to be switched from a negative stiffness to a positive stiffness by simply reversing the direction of the current flowing through the solenoids. Furthermore, the device can be optionally switched from having a linear stiffness characteristic to having either a softening stiffness characteristic (by energizing only the middle solenoid) or a hardening stiffness characteristic (by energizing only the outer coils).

A device according to the present invention may be used to damp a variety of different systems which are susceptible to problematic vibrations including aerospace structures, civil structures such as high rise buildings, bridges and flexible bridge stay cables, as well as mechanical structures such as car seats and isolation tables for vibration sensitive equipment where vibration isolation is particularly important and desirable.

The above embodiments are described by way of example only. Many variations are possible without departing from the scope of the invention as defined in the appended claims.

What is claimed is:

1. An apparatus for negative stiffness comprising:
one or more solenoids for generating a magnetic field; and
a moveable magnet moveable relative to the one or more solenoids through the one or more solenoids, wherein the one or more solenoids are configured to generate an at least substantially quadratic magnetic field about an equilibrium position at which the resultant force on the moveable magnet is zero.

2. The apparatus of claim 1, the one or more solenoids further comprise:
a first solenoid;
a second solenoid arranged to one side of the first solenoid; and
a third solenoid arranged to the opposite side of the first solenoid, wherein the one or more solenoids are arranged relative to one another such that the quadratic magnetic field is substantially symmetrical about the first solenoid.

3. The apparatus of claim 2, wherein the second solenoid and the third solenoid are equidistant from the first solenoid.

4. The apparatus of claim 3, further comprising:
one or more additional solenoids arranged to one side of the second solenoid; and
one or more additional solenoids arranged to one side of the third solenoid.

5. The apparatus of claim 4, wherein the first solenoid, the second solenoid, the third solenoid, the one or more additional solenoids arranged to one side of the second solenoid, and the one or more additional solenoids arranged to one side of the third solenoid are substantially equally spaced apart.

6. The apparatus of claim 1, further comprising:
one or more solenoids arranged relative to the moveable magnet to provide softening negative stiffness with displacement of the moveable magnet; and
one or more solenoids arranged relative to the moveable magnet to provide hardening negative stiffness with displacement of the moveable magnet.

7. The apparatus of claim 6, wherein the solenoids are configurable to produce a combined negative stiffness with a substantially linear characteristic with displacement.

8. The apparatus of claim 2, wherein a coil geometry of the first solenoid, a coil geometry of the second solenoid, and a coil geometry of the third solenoid are substantially the same.

9. The apparatus of claim 2, wherein the first solenoid, the second solenoid, and the third solenoid are wound in the same direction.

10. The apparatus of claim 1, wherein the one or more solenoids and the moveable magnet are configurable such that the magnetization of the one or more solenoids and the moveable magnet is in substantially the same direction.

11. The apparatus of claim 2, wherein the first solenoid, the second solenoid, and the third solenoid are aligned along a common longitudinal axis.

12. The apparatus of claim 1, wherein the moveable magnet is fixedly mounted to a shaft for transmission of external vibrations to the moveable magnet.

13. The apparatus of claim 1, wherein the one or more solenoids and the moveable magnet have a substantially circular cross-sectional configuration.

14. The apparatus of claim 13, wherein the one or more solenoids and the moveable magnet are substantially concentric.

15. A method of suppressing vibrations comprising the steps of:
providing an apparatus comprising one or more solenoids for generating a magnetic field and a moveable magnet moveable relative to the one or more solenoids through the one or more solenoids, wherein the one or more solenoids are configured to generate an at least substantially quadratic magnetic field about an equilibrium position at which the resultant force on the moveable magnet is zero;
connecting the moveable magnet to a source of external vibrations; and
energizing the one or more solenoids to provide a desired stiffness characteristic with displacement of the moveable magnet, wherein the one or more solenoids are each energized with a current required to generate a substantially quadratic magnetic field through the one or more solenoids.
